(19) United States
(12) Patent Application Publication
(10) Pub. No.: US 2015/0154477 A1
(43) Pub. Date: Jun. 4, 2015

(54) IMAGE FORMING APPARATUS, METHOD FOR CALIBRATING PRINT DENSITY, AND COMPUTER-READABLE RECORDING MEDIUM

(71) Applicant: Samsung Electronics Co., Ltd., Suwon-si (KR)

(72) Inventors: Jae-bum YOO, Suwon-si (KR); Jong-cheol Oh, Suwon-si (KR); Hae-kee Lee, Yongin-si (KR)

(73) Assignee: Samsung Electronics Co., Ltd., Suwon-si (KR)

(21) Appl. No.: 14/304,273

(22) Filed: Jun. 13, 2014

(30) Foreign Application Priority Data
Dec. 2, 2013 (KR) 10-2013-0148256

(51) Int. Cl. G06K 15/02

(52) U.S. Cl. CPC G06K 15/027

(57) ABSTRACT

An image forming apparatus, a method, and a non-transitory computer-readable recording medium are provided. The apparatus includes an image former configured to form patches for print density calibration on an image forming medium, a print density sensor configured to sense a print density for the plurality of reflective patches formed on the image forming medium, a calculator configured to calculate calibration coefficients of the sensor based on the sensed print densities, and a calibrator configured to perform the print density calibration using the calculated calibration coefficients.

### CROSS-REFERENCE TO RELATED APPLICATIONS

This application is related to, and claims priority to, Korean Patent Application No. 10-2013-0148256, filed on Dec. 2, 2013, in the Korean Intellectual Property Office, the disclosure of which is incorporated herein by reference.

### BACKGROUND

1. Field

Exemplary embodiments relate to an image forming apparatus, a method for calibrating a print density, and a computer-readable recording medium, and more particularly to an image forming apparatus, a method for calibrating a print density, and a computer-readable recording medium, which can calibrate the print density through calibration of an error that may occur in a sensor for print density calibration.

2. Description of the Related Art

In general, an image forming apparatus may be defined as an apparatus which prints print data that is generated by a print control terminal device on print sheets, and examples thereof may be a copy machine, a printer, a facsimile, and a multifunction peripheral (MFP) in which two or more functions of the above-described devices are combined.

In such an image forming apparatus, uniformity of the print density may be changed depending, for example, on environmental change of surroundings, continuous printing, or replacement of toner or developer. Accordingly, the image forming apparatus performs print density calibration to reproduce initial output characteristics.

According to a general method for performing the print density calibration, the print density may be measured using a spectrometer. The print density of the output may be compared with a reference print density to calibrate the print density. However, it may be difficult for a general user to use this method using the spectrometer on the points as the measurement device is expensive and it may take a long time to perform the measurement.

According to another method for performing the print density calibration, an image, which is formed on a transfer belt or an OPC on which toner is developed, may be measured using an internal sensor device. The measured value may be converted into an optical density (OD) value that is measured by a spectrometer to calibrate the print density. This method is widely used on the points since the spectrometer is less expensive than a spectrometer and it may not be necessary for a user to perform an additional method for calibrating the print density.

However, the print density calibration as described above assumes that a print density sensor, which is a sensor device that senses the image formed on the transfer belt, can always read the same sensed value. However, a light receiver or a light emitter of the sensor may be polluted, for example, by toner scattering that is generated in the image forming apparatus. Such pollution may cause occurrence of an error in the value sensed by the light receiver. The existing print density calibration methods do not consider such an error occurrence, and thus the calibration may be performed with a print density that is different from the print density intended by the user.

### SUMMARY

Exemplary embodiments address the above problems and/or disadvantages and provide at least the advantages disclosed herein. Accordingly, an aspect of an exemplary embodiment provides an image forming apparatus, a method for calibrating a print density, and a non-transitory computer-readable recording medium, which can calibrate the print density through calibration of an error that may occur in a sensor for print density calibration.

According to an aspect of an exemplary embodiment, an image forming apparatus includes an image former configured to form a plurality of reflective patches having different brightness levels for print density calibration on an image forming medium, a print density sensor configured to sense a print density for the plurality of reflective patches formed on the image forming medium, and a calibrator configured to perform the print density calibration according to the sensed print density, wherein the reflective patch is a contone image having an equal brightness value in the reflective patch.

The print density sensor may sense the print density for the formed reflective patches at a plurality of positions, and the image forming apparatus may include a calculator configured to calculate calibration coefficients of the sensor based on the print density sensed at the plurality of positions.

The calibrator may correct the sensed print density value based on the calculated calibration coefficients and calibrate the print density of the image forming apparatus using the corrected sensed value.

The image forming apparatus according to the aspect of an exemplary embodiment may include a controller configured to control the image former, the print density sensor, and the calculator to calculate the calibration coefficients of the sensor using a plurality of contone images having different brightness levels if the print density calibration is necessary, and to control the image former, the print density sensor, and the calculator to perform the print density calibration using a plurality of halftone images having different brightness levels if the calibration coefficients are calculated.

The plurality of halftone images may have common cluster positions, and clusters may have different sizes according to the brightness levels.

The print density sensor may include a light emitter configured to emit light to a pattern; a first light receiver configured to sense a value of the light regular-reflected from the pattern; and a second light receiver configured to sense a value of the light scattered-reflected from the pattern.

The first light receiver and the second light receiver may convert the sensed value into an OD value that is measured by a spectrometer to output the converted OD value.

The image forming apparatus according to the aspect of an exemplary embodiment may include a medium driver configured to rotate the image forming medium; and a controller configured to control the medium driver to rotate the image forming medium in a process of forming a pattern for the print density calibration and in a process of sensing the print density for the formed pattern.

The image forming medium may be at least one of a photosensitive drum, an intermediate transfer belt, and a sheet conveyance belt.

According to an aspect of an exemplary embodiment, a method for calibrating a print density in an image forming apparatus includes forming a plurality of reflective patches having different brightness levels for print density calibration on an image forming medium, sensing a print density for the plurality of reflective patches formed on the image forming medium, and performing the print density calibration according to the sensed print density, wherein the reflective patch is a contone image having an equal brightness value in the reflective patch.

The sensing may sense the print density for the formed reflective patches at a plurality of positions, and the method for calibrating a print density may include calculating calibration coefficients of the sensor based on the print density sensed at the plurality of positions.

The performing the print density calibration may correct the sensed print density value based on the calculated calibration coefficients and calibrate the print density of the image forming apparatus using the corrected sensed value.

The method for calibrating a print density according to an aspect of an exemplary embodiment includes forming a plurality of halftone images having different brightness levels; and sensing the print density for the plurality of halftone images formed using the calculated calibration coefficients, wherein the performing the print density calibration may perform the print density calibration with respect to the halftone images using the sensed print density.

The plurality of halftone images may have common cluster positions, and clusters may have different sizes according to the brightness levels.

The sensing may include emitting light to a pattern, sensing a value of the light regular-reflected from the pattern; and sensing a value of the light scattered-reflected from the pattern.

The sensing may convert the value of the regular-reflected or scattered-reflected light into an OD value that is measured by a spectrometer to output the converted OD value.

The image forming medium may be at least one of a photosensitive drum, an intermediate transfer belt, and a sheet conveyance belt.

According an exemplary embodiment, a non-transitory computer-readable recording medium includes a program for executing a method for calibrating a print density, wherein the method for calibrating a print density includes forming a plurality of reflective patches having different brightness levels for print density calibration on an image forming medium, sensing a print density for the plurality of reflective patches formed on the image forming medium, and performing the print density calibration according to the sensed print density, wherein the reflective patch is a contone image having an equal brightness value in the reflective patch.

### BRIEF DESCRIPTION OF THE DRAWINGS

The above and other aspects, features and advantages of an exemplary embodiment will be more apparent from the following detailed description when taken in conjunction with the accompanying drawings, in which:

FIG. 1 illustrates an image forming apparatus according to an embodiment;

FIG. 2 illustrates an exemplary configuration of a calibrator;

FIG. 3 illustrates an exemplary contone pattern;

FIG. 4 illustrates an exemplary halftone pattern;

FIGS. 5 and 6 illustrates an exemplary relationship between sensing values of a first light receiver and OD;

FIGS. 7 and 8 illustrate exemplary effects of an embodiment;

FIG. 9 illustrates a method for calibrating a print density according to an embodiment; and

FIG. 10 illustrates a method for calibrating a print density according to an embodiment.

### DETAILED DESCRIPTION

Exemplary embodiments are described in detail with reference to the accompanying drawings.

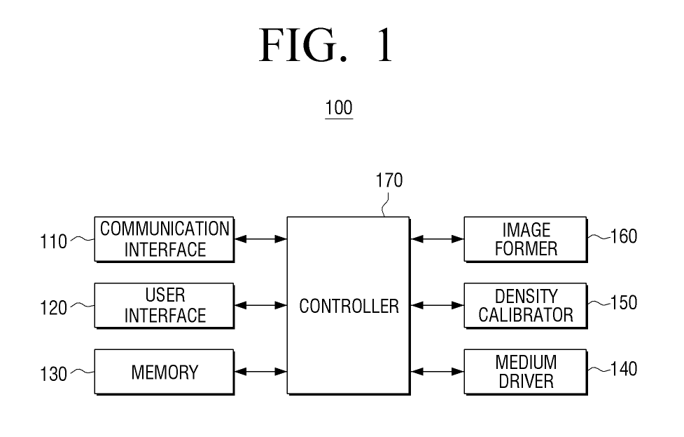

FIG. 1 is a block diagram illustrating an image forming apparatus according to an embodiment.

Referring to FIG. 1, an image forming apparatus 100 includes a communication interface 110, a user interface 120, a memory 130, a medium driver 140, a print density calibrator 150, an image former 160, and a controller 170. The image forming apparatus 100 may be a copy machine that requires print density calibration, a printer, a facsimile, or a multifunction peripheral (MFP) in which two or more functions of the above-described devices are combined.

The communication interface 110 may be connected to a print control terminal device (not illustrated). The communication interface 110 may connect the image forming apparatus 100 to an external device. The communication interface 110 may connect to the print control terminal device (not illustrated) through not only a LAN (Local Area Network) and the Internet, but also, for example, to a USB (Universal Serial Bus) port. A communication interface 110 may be implemented to connect to the print control terminal device (not illustrated) not only in a wired method, but also in a wireless method. The print control terminal device may be a PC, a notebook PC, a digital camera, a smart phone, a PMP, or an MP3 player.

The communication interface 110 receives print data from the print control terminal device. The communication interface 110 may receive a command to perform a print density calibration from the print control terminal device. The print density calibration may be performed even in the case where a color registration is performed, A print density calibration command may be a command for color registration.

The user interface 120 may be provided with a plurality of function keys for a user to set or select various kinds of functions supported by the image forming apparatus 100, and display various kinds of information provided from the image forming apparatus 100. The user interface 120 may be implemented by a device on which input and output operations may be simultaneously performed, such as a touch screen, or through a combination of a mouse and a monitor. A user may input the command for color registration with respect to the image forming apparatus 100 using a user interface window provided through the user interface 120.

The memory 130 stores print data. The memory 130 stores print data that may be received through the communication interface 110. The memory 130 may store history information of a print job that is performed in the image forming apparatus 100. The memory 130 may store calibration coefficients calculated by the print density calibrator 150, sensed print density values, and a reference print density value for the print density calibration.

The memory 130 may be implemented by a storage medium in the image forming apparatus 100 and an external storage medium, for example, a removable disk including a USB memory or a web server through a network. The memory 130 may be positioned on the outside of the print density calibrator 150. The memory 130 may be implemented in a form that is positioned in the print density calibrator 150.

The medium driver 140 rotates the image forming medium. The medium driver 140 may drive the image forming medium, such as a photosensitive drum (OPC) on which an image is formed, an intermediate transfer belt (ITC), or a sheet conveyance belt.

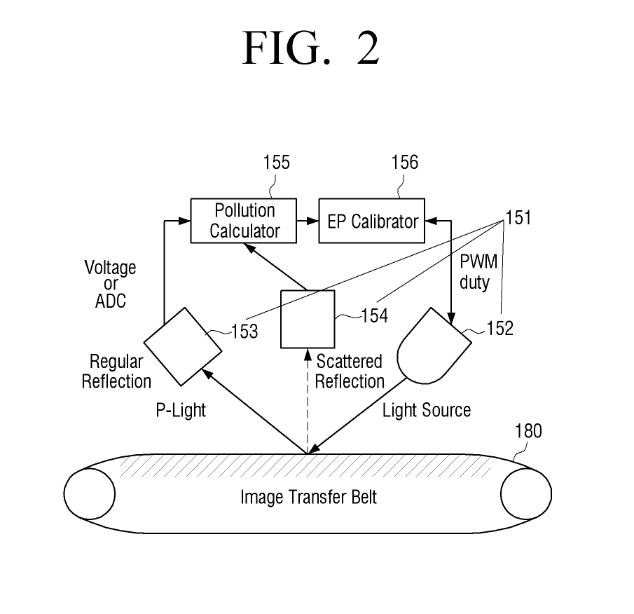

If the print density calibration is required, the print density calibrator 150 calculates calibration coefficients of a sensor that senses the print density. The print density calibrator 150 calibrates the sensed print density based on the calculated calibration coefficients, compares the calibrated print density value with a reference print density value (pre-stored value), and changes development conditions (charge voltage, LD power, and the like) so that a developer performs development with a print density that corresponds to the reference print density value. An exemplary configuration and operation of the print density calibrator 150 is described with reference to FIG. 2.

The image former 160 forms an image. The image former 160 may form an image on the image forming medium on which the image is formed, such as the photosensitive drum, the intermediate transfer belt, or the sheet conveyance belt.

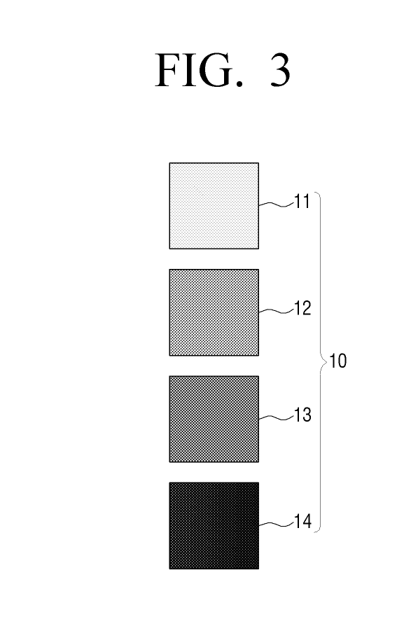

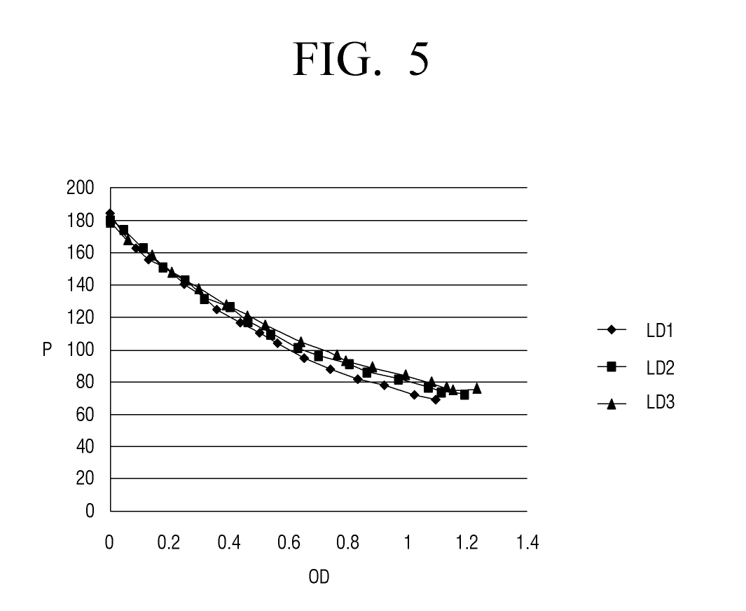

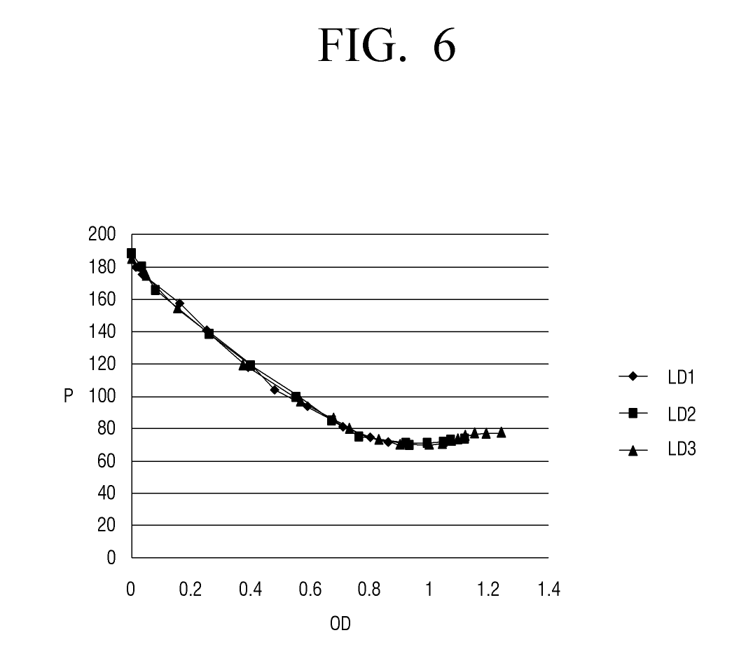

The image former 160 may form a pattern for the print density calibration on the image forming medium. As illustrated in FIG. 3, the image former 160 may form a plurality of contone images having different brightness levels. According to an embodiment, the contone images may be used for the pattern, but halftone images may be used during implementation. In a case of calculating calibration coefficients during implementation, the contone images may be used, while in a case of performing the actual print density calibration, the halftone images may be used. An exemplary use of contone images to calculate the calibration coefficients is described with reference to FIGS. 5 and 6.

The controller 170 controls the respective configurations in the image forming apparatus 100. If print data is received from a print control terminal device, the controller 170 may control the image former 160 to print the received print data.

The controller 170 may determine whether it is necessary to perform the print density calibration. If the image forming apparatus 100 performs printing for a redetermined number of print sheets based on the history information stored in the memory 130 or if a command for the print density calibration is input from the print control terminal device or the user interface 120, the controller 170 may determine that it is necessary to perform the print density calibration. Even in a case where color registration is necessary, the above-described operation may be performed.

If it is determined that it is necessary to perform the print density calibration, the controller 170 may control the medium driver 140, the print density calibrator 150, and the image former 160 to perform the print density calibration. Different patterns may be used to perform calculation of the calibration coefficients and print density calibration. The controller 170 may control, e.g., primarily control the medium driver 140, the print density calibrator 150, and the image former 160 to calculate the calibration coefficients through the contone pattern, and may control the medium driver 140, the print density calibrator 150, and the image former 160 to perform the print density calibration with respect to the halftone pattern according to the calculated calibration coefficients.

The image forming apparatus 100 according to an embodiment can perform precise print density calibration through performing the print density calibration in consideration of the pollution state of the sensor that is used to perform the print density calibration. The image forming apparatus 100 can precisely calculate the calibration coefficients through calculating the calibration coefficients using the contone images capable of sensing the print density value that is not related to the characteristics of the light emitter.

FIG. 2 is a diagram illustrating an exemplary configuration of a calibrator, for example, in FIG. 1.

Referring to FIG. 2, a print density calibrator includes a print density sensor 151, a calculator 155, and an EP calibrator 156.

The print density sensor 151 senses the print density for the pattern formed on an image forming medium 180 at a plurality of positions. The print density sensor 151 includes a light emitter 152, a first light receiver 153, and a second light receiver 154. The light emitter 152 emits light to the image forming medium 180, and the first light receiver 153 senses the light that is regular-reflected from the pattern formed on the image forming medium 180 from the light emitted from the light emitter 152. The second light receiver 154 senses the light that is scattered-reflected from the pattern formed on the image forming medium 180 from the light emitted from the light emitter 152. The light emitter 152 may be implemented by an LED. A control signal that is input to the light emitter 152 may be a PWM signal having a constant duty for controlling the quantity of light from the LED.

The calculator 155 calculates the calibration coefficients of the sensor based on the sensed print density values. An exemplary calculation method is described using the following equations.

The first light receiver 153 and the second light receiver 154 converts the sensed light into OD values that are measured by a spectrometer, and the value of the light received in the first light receiver 153 (the value of the received light of regular reflection) may be expressed as in Equation 1 below.

pₙ=p₀ƒ(Oₙ) [Equation 1]

In Equation 1, pₙ denotes a sensed value of a P wave of a patch n, P₀ denotes a sensed value of the P wave of a white patch, and Oₙ denotes an OD of the patch n.

The value of the light received in the second light receiver 154 (the value of the received light of regular reflection) may be expressed as in Equation 2 below.

Oₙ=γsₙ [Equation 2]

In Equation 2, γ denotes a constant that is varied according to pollution or an environment of the image forming apparatus, and Sₙ denotes a sensed value of an S wave of a patch n.

If a P wave and an S wave having different pollution degrees of the sensor are defined as ƒ and ƒ̅, a difference between two functions may be expressed as in Equation 3 below.

ƒ(γs)− ƒ̅( γ̅s)∝s [Equation 3]

By combining Equations 1, 2, and 3, the sensed values of the patch Pₙ and Sₙ may be expressed as in Equation 4 that is a second-order polynomial.

pₙ=c₀+c₁sₙ+c₂sₙ² [Equation 4]

The pollution calibration coefficients of the sensor may be obtained by linear-fitting the sensed value of the patch, Pₙ, and Sₙ into the above-described Equation 4. If the coefficients of the reference function ƒ are q₀, q₁, and q₂, the pollution calibration coefficient γ of the S wave may be expressed as in Equation 5 below.

$$γ = 1000.0 \sqrt{\frac{{c}_{2} {q}_{ref 0}}{{c}_{0} {q}_{ref 2}}} \qquad [ Equation 5 ]$$

The EP calibrator 156 performs the print density calibration using the calculated calibration coefficients. The EP calibrator 156 corrects the print density value that is sensed by the print density sensor 151 to the calculated calibration coefficient, compares the corrected print density value with the reference print density value, and changes development conditions (charge voltage, LD power, and the like) so that a developer performs development with a print density that corresponds to the reference print density value.

Calculation of the calibration coefficients and the print density calibration may be performed through forming of one pattern. However, during implementation, the calculation of the calibration coefficients and the print density calibration may be performed by other patterns.

The calculation of the calibration coefficients may be performed through sensing of contone patterns as illustrated in FIG. 3, and the print density calibration may be performed through sensing of halftone patterns. Exemplary use of contone patterns to calculate the calibration coefficients is described with reference to FIG. 5. An exemplary use of halftone patterns to perform the print density calibration is that brightness adjustment is performed through the halftone in an actual printing process of the image forming apparatus 100 and thus the print density calibration is to be performed in the same condition as that of the actual output.

Referring to FIG. 2, calibration coefficients are calculated using two light receivers. However, during implementation, three or more light receivers may be used to calculate the calibration coefficients.

FIG. 3 is a diagram illustrating an example of a contone pattern 10.

Referring to FIG. 3, a plurality of contone images 11, 12, 13, and 14 having different brightness levels are arranged in a line.

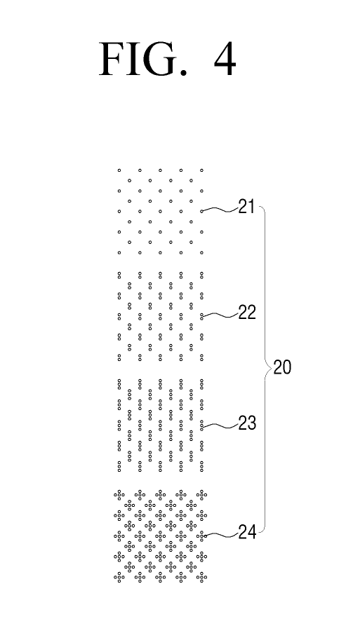

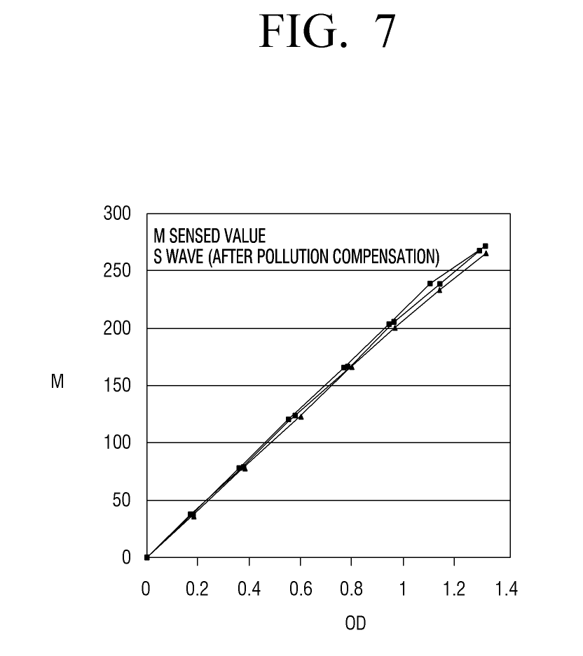

The contone image is not a clustered type image as illustrated in FIG. 4, but is an image in which the print density and brightness are adjusted through configuration of pixels that form the whole image with one PWM only, and thus the brightness values between the pixels in the image that is a reflective patch are equal to each other. The contone image may have the relationship between the OD and the P wave that is not related to the LD conditions as illustrated, for example, in FIG. 7.

FIG. 4 is a diagram illustrating an example of a halftone pattern 20.

Referring to FIG. 4, a plurality of halftone images 21, 22, 23, and 24 having different brightness levels are arranged in a line.

The halftone image may be a clustered type image. The halftone images have the same cluster positions, and clusters may have different sizes according to the brightness levels. The halftone images may be somewhat affected by the LD conditions, as illustrated in FIG. 5, and use of t contone patterns in calculating the calibration coefficients may be advantageous. However, during the actual printing of the image forming apparatus, the halftone type may be used, and the print density calibration after calculation of the calibration coefficients may be performed using the halftone images.

FIGS. 5 and 6 are diagrams illustrating the relationship between sensing values of a first light receiver and an OD. FIG. 5 illustrates the relationship between the sensed values of the P wave for the halftone patterns and the OD, and FIG. 6 illustrates the relationship between the sensed values of the P wave for the contone patterns and the OD.

Referring to FIGS. 5 and 6, if the LD conditions are changed in the case where the halftone patterns are used, it may be confirmed that the relationship between the P wave and the OD does not exist on the same line. In contrast, even if the LD conditions are changed in the case where the contone patterns are used, it may be confirmed that the relationship between the P wave and the OD exists on the same line.

Accordingly, by applying the content patterns, an error caused by the LD conditions can be minimized, and the error during the curve fitting can be minimized when the pollution calibration coefficients are calculated through Equation 5 as described above.

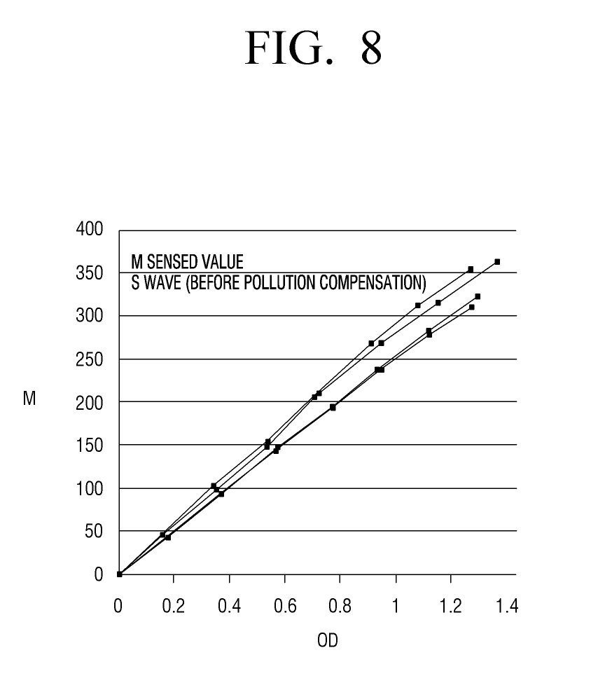

FIGS. 7 and 8 are diagrams illustrating effects of an exemplary embodiment. FIG. 7 is a diagram illustrating the relationship between the sensed value of the P wave and the OD in the case where the calibration coefficients are applied, and FIG. 8 is a diagram illustrating the relationship between the sensed value of the P wave and the OD in the case where the calibration coefficients are not applied.

Referring to FIGS. 7 and 8, if the calibration coefficients are not applied, the relationship between the sensed value and the OD does not have consistency, while if the calibration coefficients are applied according to this embodiment, the relationship between the sensed value and the OD has consistency.

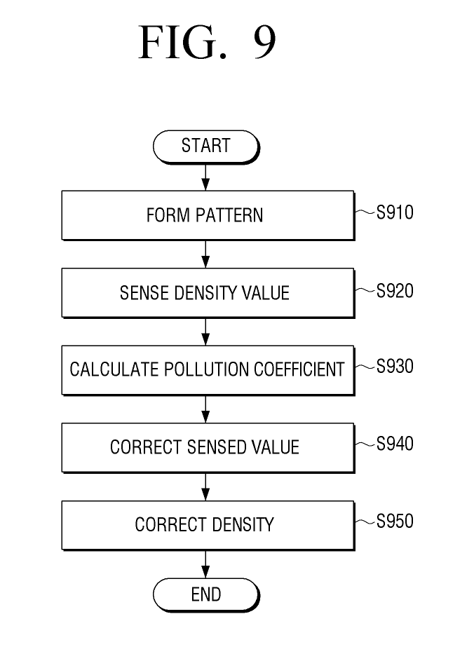

FIG. 9 is a flowchart illustrating a method for calibrating a print density according to an embodiment.

Referring to FIG. 9, a pattern for print density calibration is formed on an image forming medium (S910). A plurality of contone images having different brightness levels may be formed on the image forming medium, such as a photosensitive drum, an intermediate transfer belt, or a sheet conveyance belt. As an example, the contone image is an image having an equal brightness value.

The print density for the formed pattern is sensed at a plurality of positions (S920). Light is irradiated onto the pattern, and a value of the light that is regular-reflected from the pattern and a value of the light that is scattered-reflected from the pattern may be sensed using a plurality of sensors.

The calibration coefficients of the sensor are calculated based on the sensed print density values (S930). The calibration coefficients may be calculated using the above-described equations in relation to FIG. 2.

The print density calibration is performed using the calculated calibration coefficients (S940). A sensed value of regular reflection is corrected based on the calculated calibration coefficients, and the print density of the image forming apparatus may be calibrated using the corrected sensed value.

A method for calibrating the print density according to the first embodiment can perform precise print density calibration through performing the print density calibration in consideration of the pollution state of the sensor that is used to perform the print density calibration. The method for calibrating the print density can precisely calculate the calibration coefficients through calculating the calibration coefficients using the contone images capable of sensing the print density value that is not related to the characteristics of the light emitter. The method for calibrating the print density illustrated in FIG. 9 may be executed on the image forming apparatus having the configuration of FIG. 1, and may be executed on the image forming apparatus having other configurations.

The method for calibrating the print density as described above may be implemented by a program (or application) that includes an executable algorithm that can be executed by a computer, and the program may be stored and then provided in a non-transitory computer readable medium.

The non-transitory computer readable medium is not a medium that stores data for a short period, such as a register or a cache, but may be defined as a medium which, for example, semi-permanently or permanently stores data. and is readable by a device. An exemplary application and program may be stored and provided in the non-transitory computer readable medium, such as, a CD, a DVD, a hard disc, a Blu-ray disc, a USB, a memory card, and a ROM.

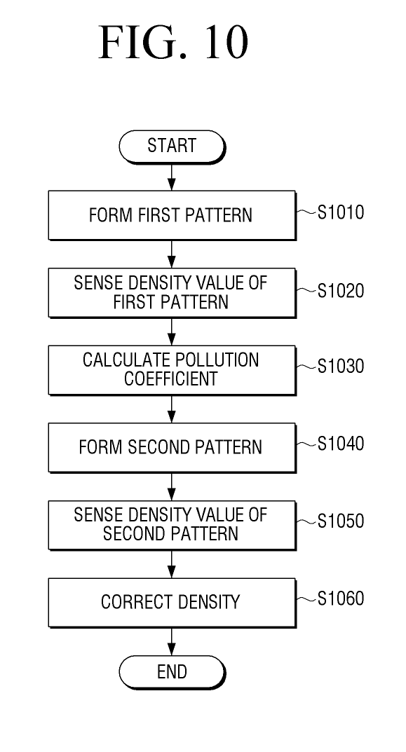

FIG. 10 illustrates an exemplary method for calibrating a print density according to an embodiment.

Referring to FIG. 10, a first pattern for calculating calibration coefficients is formed (S1010). The first pattern corresponds to a plurality of contone images.

The print density for the first pattern is sensed at a plurality of positions (S1020). Light is irradiated onto the pattern, and a value of the light that is regular-reflected from the pattern and a value of the light that is scattered-reflected from the pattern may be sensed using a plurality of sensors.

The calibration coefficients of the sensor are calculated based on the sensed print density values (S1030). The calibration coefficients may be calculated using the above-described equations in relation to FIG. 2.

A second pattern for print density calibration is formed (S1040). The second pattern corresponds to a plurality of halftone images.

The print density for the second pattern is sensed (S1050). The print density calibration is performed based on the sensed print density (S1060). The print density sensed for the second pattern may be calibrated using the calibration coefficients calculated in the above-described process, and the print density calibration for the halftone pattern may be performed based on the calibrated print density.

A method for calibrating the print density according to an embodiment can perform precise print density calibration through performing the print density calibration in consideration of the pollution state of the sensor that is used to perform the print density calibration. The method for calibrating the print density can perform the print density calibration more precisely using the halftone pattern that is a pattern formed during the actual printing job. The method for calibrating the print density according to the san embodiment, as illustrated, for example, in FIG. 10 may be executed on the image forming apparatus, for example, having the configuration of FIG. 1, and may be executed on the image forming apparatus having other configurations.

An exemplary embodiment of a method for calibrating the print density may be implemented by a program (or application) that includes an executable algorithm that can be executed by a computer, and the program may be stored and provided in a non-transitory computer readable medium.

While the disclosure has been shown and described with reference to certain embodiments thereof, it will be understood by those skilled in the art that various changes in form and detail may be made therein without departing from the spirit and scope of the present disclosure.

1. An image forming apparatus comprising:
an image former configured to form a plurality of reflective patches having different brightness levels for print density calibration on an image forming medium;
a print density sensor configured to sense a print density for the plurality of reflective patches formed on the image forming medium; and
a calibrator configured to perform the print density calibration according to the sensed print density,
wherein the reflective patch is a contone image having an equal brightness value in the reflective patch,
wherein the image forming medium is at least one of a photosensitive drum, an intermediate transfer belt, and a sheet conveyance belt.

2. The image forming apparatus as claimed in claim 1, wherein the print density sensor senses the print density for the formed reflective patches at a plurality of positions, and
the image forming apparatus further comprises a calculator configured to calculate calibration coefficients of the sensor based on the print density sensed at the plurality of positions.

3. The image forming apparatus as claimed in claim 2, wherein the calibrator corrects the sensed print density value based on the calculated calibration coefficients and calibrates the print density of the image forming apparatus using the corrected sensed value.

4. The image forming apparatus as claimed in claim 2, further comprising a controller configured to control the image former, the print density sensor, and the calculator to calculate the calibration coefficients of the sensor using a plurality of contone images having different brightness levels if the print density calibration is necessary, and to control the image former, the print density sensor, and the calculator to perform the print density calibration using a plurality of halftone images having different brightness levels if the calibration coefficients are calculated.

5. The image forming apparatus as claimed in claim 4, wherein the plurality of halftone images have common cluster positions, and clusters have different sizes according to the brightness levels.

6. The image forming apparatus as claimed in claim 1, wherein the print density sensor comprises:
a light emitter configured to emit light to a pattern,
a first light receiver configured to sense a value of the light regular-reflected from the pattern, and
a second light receiver configured to sense a value of the light scattered-reflected from the pattern.

7. The image forming apparatus as claimed in claim 6, wherein the first light receiver and the second light receiver convert the sensed value into an optical density (OD) value that is measured by a spectrometer to output the converted OD value.

8. The image forming apparatus as claimed in claim 1, further comprising:
a medium driver configured to rotate the image forming medium; and
a controller configured to control the medium driver to rotate the image forming medium in a process of forming a pattern for the print density calibration and in a process of sensing the print density for the formed pattern.

9. (canceled)

10. A method for calibrating a print density in an image forming apparatus, comprising:
forming a plurality of reflective patches having different brightness levels for print density calibration on an image forming medium;
sensing a print density for the plurality of reflective patches formed on the image forming medium; and
performing the print density calibration according to the sensed print density,
wherein the reflective patch is a contone image having an equal brightness value in the reflective patch,
wherein the image forming medium is at least one of a photosensitive drum, an intermediate transfer belt, and a sheet conveyance belt.

11. The method as claimed in claim 10, wherein the sensing senses the print density for the formed reflective patches at a plurality of positions, and
the method further comprises calculating calibration coefficients of the sensor based on the print density sensed at the plurality of positions.

12. The method as claimed in claim 11, wherein the performing the print density calibration corrects the sensed print density value based on the calculated calibration coefficients and calibrates the print density of the image forming apparatus using the corrected sensed value.

13. The method as claimed in claim 11, further comprising:
forming a plurality of halftone images having different brightness levels; and
sensing the print density for the plurality of halftone images formed using the calculated calibration coefficients,
wherein the performing the print density calibration performs the print density calibration with respect to the halftone images using the sensed print density.

14. The method as claimed in claim 13, wherein the plurality of halftone images have common cluster positions, and clusters have different sizes according to the brightness levels.

15. The method as claimed in claim 10, wherein the sensing comprises:
emitting light to a pattern,
sensing a value of the light regular-reflected from the pattern, and
sensing a value of the light scattered-reflected from the pattern.

16. The method as claimed in claim 15, wherein the sensing converts the value of the regular-reflected or scattered-reflected light into an optical density (OD) value that is measured by a spectrometer to output the converted OD value.

17. (canceled)

18. A non-transitory computer-readable recording medium comprising a program for executing a method for calibrating a print density, wherein the method includes:
forming a plurality of reflective patches having different brightness levels for print density calibration on an image forming medium;
sensing a print density for the plurality of reflective patches formed on the image forming medium; and
performing the print density calibration according to the sensed print density,
wherein the reflective patch is a contone image having an equal brightness value in the reflective patch,
wherein the image forming medium is at least one of a photosensitive drum, an intermediate transfer belt, and a sheet conveyance belt.
